(19) United States
(12) Patent Application Publication
(10) Pub. No.: US 2025/0330786 A1
(43) Pub. Date: Oct. 23, 2025

(54) SENSING TASK HANDOVER METHOD AND APPARATUS

(71) Applicant: HUAWEI TECHNOLOGIES CO., LTD., Shenzhen (CN)

(72) Inventors: Xiaohui LI, Shenzhen (CN); Jiajin LUO, Shenzhen (CN); Ping ZHANG, Shenzhen (CN)

(21) Appl. No.: 19/251,953

(22) Filed: Jun. 27, 2025

Related U.S. Application Data
(63) Continuation of application No. PCT/CN2022/142989, filed on Dec. 28, 2022.

(51) Int. Cl. H04W 4/38; H04L 67/1001

(52) U.S. Cl. CPC H04W 4/38; H04L 67/1001

(57) ABSTRACT

A sensing task handover method and an apparatus are provided. The method includes: A first communication apparatus sends a first handover request to a second communication apparatus, where the first handover request includes indication information of a context of a sensing task; and the first communication apparatus receives a first handover response from the second communication apparatus, where the first handover response includes indication information indicating whether to agree to the first handover request. In a scenario in which a to-be-sensed target and/or the first communication apparatus move/moves, the first communication apparatus cannot continue to support a current sensing task, or the like, continuity and stability of the sensing task are implemented through handover of the sensing task.

### CROSS-REFERENCE TO RELATED APPLICATIONS

This application is a continuation of International Application No. PCT/CN2022/142989, filed on Dec. 28, 2022, the disclosure of which is hereby incorporated by reference in its entirety.

### TECHNICAL FIELD

Embodiments of this application relate to the field of communication technologies, and in particular, to a sensing task handover method and an apparatus.

### BACKGROUND

In a wireless sensing technology, changes of radio signals during propagation are analyzed, to obtain a characteristic of a signal propagation space (channel) and sense a to-be-sensed target. In a communication system, a communication apparatus may be used to sense the to-be-sensed target. During sensing, movement of the communication apparatus and/or movement of the to-be-sensed target may cause interruption of a sensing task. For example, when a mobile terminal is used as a sensing device to sense the to-be-sensed target, as the terminal moves, the terminal may not be capable of maintaining sensing quality of service or may not be capable of continuing to participate in sensing. For another example, when a network device is used as a sensing device to sense the to-be-sensed target, as the to-be-sensed target gradually moves away from coverage of the network device, the network device may not be capable of maintaining sensing quality of service or may not be capable of continuing to participate in sensing.

Therefore, how to ensure continuity and stability of the sensing task is an urgent problem to be resolved.

### SUMMARY

This application provides a sensing task handover method and an apparatus, to ensure continuity and stability of a sensing task.

According to a first aspect, a sensing task handover method is provided. The method includes: A first communication apparatus sends a first handover request to a second communication apparatus, where the first handover request includes indication information of a context of a sensing task; and the first communication apparatus receives a first handover response from the second communication apparatus, where the first handover response includes indication information indicating whether to agree to the first handover request. Optionally, a target of the sensing task is a passive target. Optionally, the first communication apparatus is a source sensing node, or a chip or a circuit used in the source sensing node. The second communication apparatus is a target sensing node, or a chip or a circuit used in the target sensing node. Alternatively, the second communication apparatus is a sensing node other than the source sensing node and the target sensing node, or a chip, a circuit, or the like used in the another sensing node.

According to the foregoing possible implementation, the first communication apparatus being a source sensing node is used as an example. When determining that the source sensing node cannot continue to support a current sensing task, the source sensing node may send a handover request to the target sensing node or the another sensing node, and receive a handover response that is sent by the target sensing node or the another sensing node and that indicates whether to agree, to implement handover of the sensing task in a scenario in which the source sensing node and/or a to-be-sensed target move/moves, and further implement continuity, stability, and the like of the sensing task.

In a possible implementation, the context of the sensing task includes indication information of at least one of the following: an identifier of the sensing task, a sensing range of the sensing task, a performance requirement of the sensing task, a current sensing state, or a service subtype of a service type of the sensing task.

According to the foregoing possible implementation, when obtaining the context of the sensing task by using the first handover request, the target sensing node may determine, based on the context of the sensing task, whether the target sensing node can support the current sensing task, determine whether to agree to the handover, and the like. In addition, after the target sensing node agrees to the handover, the target sensing node may take over the current sensing task based on the context of the sensing task, continue the current sensing task, perform sensing, and the like.

In a possible implementation, the context of the sensing task is associated with the service type of the sensing task. For example, the service type of the sensing task is environment sensing, and the context of the sensing task includes indication information of at least one of the following: the identifier of the sensing task, a sensing area of the sensing task, a resolution of the sensing task, or a frequency of sending a sensing signal. Alternatively, the service type of the sensing task is health monitoring, and the context of the sensing task includes indication information of at least one of the following: the identifier of the sensing task, a health monitoring type, a current location of a health monitoring target object, a current direction of the health monitoring target object, a resolution of the sensing task, or a frequency of sending a sensing signal. Alternatively, the service type of the sensing task is home monitoring, and the context of the sensing task includes indication information of at least one of the following: the identifier of the sensing task, a home monitoring type, a home monitoring range, a home monitoring location, a home monitoring direction, a resolution of the sensing task, or a frequency of sending a sensing signal. Alternatively, the service type of the sensing task is mobile target sensing, and the context of the sensing task includes indication information of at least one of the following: the identifier of the sensing task, a type of a mobile target of the sensing task, a current location of the mobile target, a current moving speed of the mobile target, a current moving direction of the mobile target, a resolution of the sensing task, or a frequency of sending a sensing signal.

According to the foregoing possible implementation, content, parameters, or the like carried in the context of the sensing task may correspondingly vary with different service types of the sensing task. For a target sensing node side, in a scenario in which the handover is agreed to, various parameters of the corresponding sensing task may be directly determined based on the context of the sensing task, and the current sensing task is directly took over based on the foregoing various parameters. This improves handover efficiency.

In a possible implementation, the first handover request further includes indication information of the service type of the sensing task. Optionally, the indication information of the service type of the sensing task may be carried in the context of the sensing task. For example, in addition to the foregoing information, the context of the sensing task may further include the indication information of the service type. Alternatively, optionally, the indication information of the service type may be carried outside the context of the sensing task. For example, the first handover request includes the context, the service type, and the like of the sensing task.

According to the foregoing possible implementation, if the first handover request carries the indication information of the service type of the sensing task, the target sensing node may directly obtain the service type of the current sensing task from the first handover request, and determine, based on the service type, whether the target sensing node supports the service type of the current sensing task. If the target sensing node supports the service type of the current sensing task, whether the current sensing task is supported may be further determined based on the context of the sensing task. If the target sensing node does not support the service type of the current sensing task, the target sensing node may directly send the first handover response that includes indication information indicating that the handover is rejected. It may be seen that the first handover request includes the indication information of the service type. This improves efficiency of processing the handover request by the target sensing node. Especially in a case in which the target sensing node does not support the current sensing task, the target sensing node may directly perform determining based on the service type, without further processing on the context of the sensing task.

In a possible implementation, the first handover request further includes indication information of a sensing mode. Optionally, the sensing mode includes: A target communication apparatus is used as a transmitting sensing node; or the target communication apparatus is used as a receiving sensing node; or the target communication apparatus is used as both a transmitting sensing node and a receiving sensing node.

In a possible implementation, before the first communication apparatus sends the first handover request to the second communication apparatus, the method further includes: The first communication apparatus sends a second handover request to the second communication apparatus, where the second handover request includes indication information of a sensing mode; and the first communication apparatus receives a second handover response from the second communication apparatus, where the second handover response includes indication information indicating that the second handover request is agreed to.

According to the foregoing possible implementation, the first communication apparatus may first send the second handover request including the indication information of the sensing mode, and for a notification apparatus that supports a current sensing mode (namely, a communication apparatus that agrees to the second handover request), the first communication apparatus then sends the first handover request to the notification apparatus, to reduce transmission overheads of the first handover request.

In a possible implementation, that the first communication apparatus sends the first handover request or the second handover request to the second communication apparatus includes: The first communication apparatus broadcasts the first handover request or the second handover request, where the second communication apparatus is an apparatus capable of receiving the broadcast.

According to the foregoing possible implementation, the first communication apparatus does not need to determine the second communication apparatus, but broadcasts the first handover request and/or the second handover request, so that a requirement for the first communication apparatus is low, and energy consumption of the first communication apparatus is reduced.

According to a second aspect, a sensing task handover method is provided. The second aspect is a peer method corresponding to the first aspect above. For beneficial effect, refer to descriptions in the first aspect. Details are not described again. The second aspect method includes: A second communication apparatus receives a first handover request from a first communication apparatus, where the first handover request includes indication information of a context of a sensing task; and the second communication apparatus sends a first handover response to the first communication apparatus, where the first handover response includes indication information indicating whether to agree to the first handover request. Optionally, a target of the sensing task is a passive target. Optionally, the first communication apparatus is a source sensing node, or a chip or a circuit used in the source sensing node. The second communication apparatus is a target sensing node, or a chip or a circuit used in the target sensing node. Alternatively, the second communication apparatus is a sensing node other than the source sensing node and the target sensing node, or a chip, a circuit, or the like used in the another sensing node.

In a possible implementation, the context of the sensing task includes indication information of at least one of the following: an identifier of the sensing task, a sensing range of the sensing task, a performance requirement of the sensing task, a current sensing state, or a service subtype of a service type of the sensing task.

In a possible implementation, the context of the sensing task is associated with the service type of the sensing task.

In a possible implementation, the service type of the sensing task is environment sensing, and the context of the sensing task includes indication information of at least one of the following: the identifier of the sensing task, a sensing area of the sensing task, a resolution of the sensing task, or a frequency of sending a sensing signal.

In a possible implementation, the service type of the sensing task is health monitoring, and the context of the sensing task includes indication information of at least one of the following: the identifier of the sensing task, a health monitoring type, a current location of a health monitoring target object, a current direction of the health monitoring target object, a resolution of the sensing task, or a frequency of sending a sensing signal.

In a possible implementation, the service type of the sensing task is home monitoring, and the context of the sensing task includes indication information of at least one of the following: the identifier of the sensing task, a home monitoring type, a home monitoring range, a home monitoring location, a home monitoring direction, a home monitoring resolution, or a frequency of sending a sensing signal.

In a possible implementation, the service type of the sensing task is mobile target sensing, and the context of the sensing task includes indication information of at least one of the following: the identifier of the sensing task, a type of a mobile target of the sensing task, a current location of the mobile target, a current moving speed of the mobile target, a current moving direction of the mobile target, a resolution of the sensing task, or a frequency of sending a sensing signal.

In a possible implementation, the first handover request further includes indication information of the service type of the sensing task.

In a possible implementation, the method further includes: The second communication apparatus determines, based on the context of the sensing task, whether a condition of the sensing task is met. If the condition of the sensing task is met, the first handover response includes indication information indicating agreement; or if the condition of the sensing task is not met, the first handover response includes indication information indicating rejection.

In a possible implementation, the method further includes: The second communication apparatus sends the first handover request to a third communication apparatus; and
the second communication apparatus receives the first handover response from the third communication apparatus.

In a possible implementation, the first handover request further includes indication information of a sensing mode.

In a possible implementation, the method further includes: The second communication apparatus determines whether the sensing mode can be supported. If the second communication apparatus supports the sensing mode and meets a sensing condition corresponding to the context of the sensing task, the first handover response includes the indication information indicating agreement; or if the second communication apparatus does not meet the sensing condition and/or does not support the sensing mode, the first handover response includes the indication information indicating rejection.

In a possible implementation, before the second communication apparatus receives the first handover request from the first communication apparatus, the method further includes: The second communication apparatus receives a second handover request from the first communication apparatus, where the second handover request includes indication information of a sensing mode; and the second communication apparatus sends a second handover response to the first communication apparatus, where the second handover response includes indication information indicating that the second handover request is agreed to.

In a possible implementation, the method further includes: The second communication apparatus sends the second handover request to the third communication apparatus; and
the second communication apparatus receives the second handover response from the third communication apparatus.

In a possible implementation, the sensing mode includes: A target communication apparatus is used as a transmitting sensing node; or the target communication apparatus is used as a receiving sensing node; or the target communication apparatus is used as both a transmitting sensing node and a receiving sensing node.

In a possible implementation, the first handover request or the second handover request is broadcast, and the second communication apparatus or the third communication apparatus is an apparatus that can receive the broadcast.

According to a third aspect, an apparatus is provided. The apparatus includes a corresponding unit or module for performing the method according to the first aspect or the second aspect. The unit or module may be implemented by a hardware circuit, or may be implemented by software, or may be implemented by a combination of a hardware circuit and software.

According to a fourth aspect, an apparatus is provided. The apparatus includes a processor and an interface circuit. The interface circuit is configured to: receive a signal from an apparatus other than the apparatus and transmit the signal to the processor, or send a signal from the processor to an apparatus other than the apparatus, and the processor is configured to implement the method according to the first aspect or the method according to the second aspect through a logic circuit or by executing instructions.

According to a fifth aspect, an apparatus is provided. The apparatus includes a processor coupled to a memory. The processor is configured to execute a program stored in the memory, to perform the method according to the first aspect or the second aspect. The memory may be located inside or outside the apparatus. In addition, there may be one or more processors.

According to a sixth aspect, an apparatus is provided. The apparatus includes a processor and a memory. The memory is configured to store computer instructions. When the apparatus runs, the processor executes the computer instructions stored in the memory, to enable the apparatus to perform the method according to the first aspect or the second aspect.

According to a seventh aspect, a chip system is provided. The chip system includes a processor or a circuit, configured to perform the method according to the first aspect or the second aspect.

According to an eighth aspect, a computer-readable storage medium is provided. The computer-readable storage medium stores instructions; and when the instructions are run on a communication apparatus, the method according to the first aspect or the second aspect is performed.

According to a ninth aspect, a computer program product is provided. The computer program product includes a computer program or instructions; and when the computer program or the instructions are run by an apparatus, the method according to the first aspect or the second aspect is performed.

According to a tenth aspect, a system is provided. The system includes a first communication apparatus that performs the method according to the first aspect and a second communication apparatus that performs the method according to the second aspect.

### BRIEF DESCRIPTION OF DRAWINGS

FIG. 1 is a diagram of an architecture of a communication system to which an embodiment of this application is applied;

FIG. 2 is a flowchart of sensing task handover according to Embodiment 1 of this application;

FIG. 3 is a diagram of an application scenario according to Embodiment 1 of this application;

FIG. 4 is a diagram of an application scenario according to Embodiment 1 of this application;

FIG. 5 is a diagram of an application scenario according to Embodiment 1 of this application;

FIG. 6 is a diagram of an application scenario according to Embodiment 1 of this application;

FIG. 7 is a flowchart of sensing task handover according to Embodiment 2 of this application;

FIG. 8 is a diagram of an application scenario according to Embodiment 2 of this application;

FIG. 9 is a diagram of an application scenario according to Embodiment 2 of this application;

FIG. 10 is a diagram of an architecture of a sensing management function according to an embodiment of this application;

FIG. 11 is a diagram of a communication apparatus according to an embodiment of this application; and

FIG. 12 is another diagram of a communication apparatus according to an embodiment of this application.

### DESCRIPTION OF EMBODIMENTS

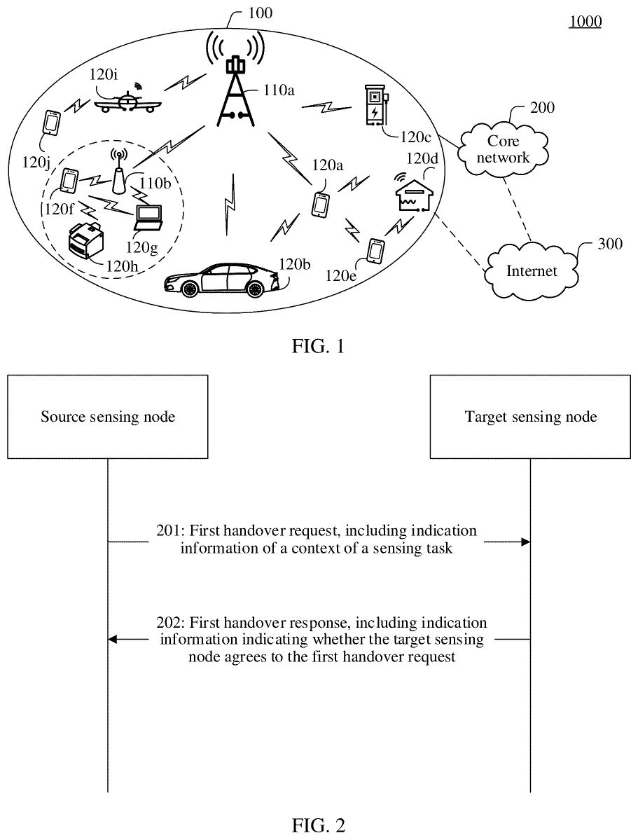

FIG. 1 is a diagram of an architecture of a communication system 1000 to which an embodiment of this application is applied. As shown in FIG. 1, the communication system includes a radio access network 100 and a core network 200. Optionally, the communication system 1000 may further include an internet 300. The radio access network 100 may be a cellular system related to the 3rd generation partnership project (3rd generation partnership project, 3GPP), for example, a 4th generation (4th generation, 4G) mobile communication system, a 5th generation (5th generation, 5G) mobile communication system, or an evolved system after 5G (for example, a 6th generation (6th generation, 6G) mobile communication system). Alternatively, the radio access network 100 may be an open access network (open RAN, O-RAN, or ORAN), a cloud radio access network (cloud radio access network, CRAN), or a wireless fidelity (wireless fidelity, Wi-Fi) system. Alternatively, the radio access network 100 may be a communication system integrating the foregoing two or more systems. The radio access network 100 may include at least one access network device (for example, 110a and 110b in FIG. 1), and may further include at least one terminal (for example, 120a to 120j in FIG. 1). The terminal is connected to the access network device in a wireless manner, and the access network device is connected to the core network in a wireless or wired manner. A core network device and the access network device may be different physical devices that are independent of each other, or functions of the core network device and logical functions of the access network device may be integrated into a same physical device, or some functions of the core network device and some functions of the access network device may be integrated into one physical device. Terminals may be connected to each other in a wired or wireless manner, and access network devices may be connected to each other in a wired or wireless manner. FIG. 1 is merely a diagram. The communication system may further include another network device, for example, may further include a wireless relay device and a wireless backhaul device, which are not shown in FIG. 1.

The access network device is a node in the radio access network 100, and may also be referred to as a radio access network (radio access network, RAN) node.

The access network device may be a base station (base station), an evolved NodeB (evolved NodeB, eNodeB), an access point (access point, AP), a transmission reception point (transmission reception point, TRP), a next generation NodeB (next generation NodeB, gNB), a next generation base station in a 6th generation (6th generation, 6G) mobile communication system, a base station in a future mobile communication system, a satellite, an access node in a Wi-Fi system, or the like. The access network device may be a macro base station (for example, 110a in FIG. 1), a micro base station or an indoor station (for example, 110b in FIG. 1), a relay node or a donor node, or a radio controller in a CRAN scenario. Alternatively, the access network device may be a device that undertakes a function of the base station in device-to-device (device-to-device, D2D) communication, internet of vehicles communication, uncrewed aerial vehicle communication, or machine-to-machine communication. Optionally, the access network device may alternatively be a server, a wearable device, a vehicle, a vehicle-mounted device, or the like. For example, an access network device in a vehicle-to-everything (vehicle-to-everything, V2X) technology may be a road side unit (road side unit, RSU).

The access network device may be a module or a unit that completes some functions of the base station. For example, a plurality of access network devices may cooperate to assist the terminal in implementing radio access, and different access network devices separately implement some functions of the base station. For example, the access network device may be a central unit (central unit, CU), a distributed unit (distributed unit, DU), a CU-control plane (control plane, CP), a CU-user plane (user plane, UP), a radio unit (radio unit, RU), or the like. The CU and the DU may be separately disposed, or may be included in a same network element, for example, a baseband unit (baseband unit, BBU). The RU may be included in a radio frequency device or a radio frequency unit, for example, included in a remote radio unit (remote radio unit, RRU), an active antenna unit (active antenna unit, AAU), or a remote radio head (remote radio head, RRH). It may be understood that the access network device may be a CU node, a DU node, or a device including the CU node and the DU node. In addition, the CU may be classified into an access network device in an access network RAN, or the CU may be classified into an access network device in the core network. This is not limited herein. Optionally, in this application, the CU completes functions of a radio resource control (radio resource control, RRC) protocol and a packet data convergence protocol (packet data convergence protocol, PDCP) of the base station, and may further complete a function of a service data adaptation protocol (service data adaptation protocol, SDAP). The DU completes functions of a radio link control (radio link control, RLC) layer and a medium access control (medium access control, MAC) layer of the base station, and may further complete functions of some physical (physical, PHY) layers or all physical layers. For specific descriptions of the foregoing protocol layers, refer to related technical specifications of the 3rd generation partnership project (3rd generation partnership project, 3GPP).

In different systems, the CU (or the CU-CP and the CU-UP), the DU, or the RU may also have different names, but a person skilled in the art may understand meanings of the names. For example, in an ORAN system, the CU may also be referred to as an O-CU (open CU), the DU may also be referred to as an O-DU, the CU-CP may also be referred to as an O-CU-CP, the CU-UP may also be referred to as an O-CU-UP, and the RU may also be referred to as an O-RU. Any unit in the CU (or the CU-CP or the CU-UP), the DU, and the RU in this application may be implemented through a software module, a hardware module, or a combination of the software module and the hardware module. A specific technology and a specific device form used by the access network device are not limited in embodiments of this application.

The terminal may also be referred to as a terminal device, user equipment (user equipment, UE), a mobile station, a mobile terminal, or the like. The terminal may be widely used in various scenarios, for example, device-to-device (device-to-device, D2D), vehicle-to-everything (vehicle-to-everything, V2X) communication, machine-type communication (machine-type communication, MTC), an internet of things (internet of things, IoT), virtual reality, augmented reality, industrial control, autonomous driving, telemedicine, a smart grid, smart furniture, a smart office, smart wearable, smart transportation, and a smart city. The terminal may be a mobile phone, a tablet computer, a computer having a wireless transceiver function, a wearable device, a smart point of sale (point of sale, POS) machine, customer-premises equipment (customer-premises equipment, CPE), a vehicle, an uncrewed aerial vehicle, a helicopter, an airplane, a ship, a robot, a robot arm, a smart home device, an IoT terminal, or the like. A specific technology and a specific device form used by the terminal are not limited in embodiments of this application.

The access network device and the terminal may be at fixed locations, or may be mobile. The access network device and the terminal may be deployed on the land, including an indoor or outdoor device, or a handheld or vehicle-mounted device; may be deployed on a water surface; or may be deployed on an airplane, a balloon, and an artificial satellite in the air. Application scenarios of the access network device and the terminal are not limited in embodiments of this application.

Roles of the access network device and the terminal may be relative. For example, a helicopter or an uncrewed aerial vehicle 120i in FIG. 1 may be configured as a mobile access network device. For the terminal 120j that accesses the radio access network 100 through 120i, the terminal 120i is an access network device. However, for the access network device 110a, 120i is a terminal, that is, 110a and 120i communicate with each other according to a radio air interface protocol. Alternatively, 110a and 120i communicate with each other according to an interface protocol between access network devices. In this case, for 110a, 120i is also an access network device. Therefore, both the access network device and the terminal may be collectively referred to as communication apparatuses. 110a and 110b in FIG. 1 may be referred to as communication apparatuses having a function of the access network device, and 120a to 120j in FIG. 1 may be referred to as communication apparatuses having a function of the terminal.

Communication between an access network device and a terminal, between access network devices, or between terminals may be performed by using a licensed spectrum, an unlicensed spectrum, or both a licensed spectrum and an unlicensed spectrum; may be performed by using a spectrum below 6 gigahertz (gigahertz, GHz); may be performed by using a spectrum above 6 GHz; or may be performed by using both a spectrum below 6 GHz and a spectrum above 6 GHz. A spectrum resource used for wireless communication is not limited in embodiments of this application.

In embodiments of this application, a function of the access network device may alternatively be performed by a module (for example, a chip) in the access network device, or may be performed by a control subsystem including the function of the access network device. The control subsystem including the function of the access network device herein may be a control center in the foregoing application scenarios such as a smart grid, industrial control, smart transportation, and a smart city. The function of the terminal may alternatively be performed by a module (for example, a chip or a modem) in the terminal, or may be performed by an apparatus including the function of the terminal.

In the communication system shown in FIG. 1, a wireless sensing technology may be used to sense a to-be-sensed target. The following describes the wireless sensing technology, and the description is not intended to limit this application.

In a wireless sensing technology, changes of radio signals are analyzed in a propagation process to obtain a characteristic of signal propagation space and sense a scenario. The signal propagation space may be considered as a channel. The scenario herein includes not only a factor of a mobile target, for example, whether there is a mobile target and a location, a direction, a posture, an action, or the like of the mobile target, but also a static target factor, for example, a building or a street.

Main application of a wireless communication system is to exchange information between transceivers. A basic principle of the wireless communication system is that a transmitter transmits a specific waveform signal, the specific waveform signal is received by a receiver through a wireless channel, and a signal transmitted by the transmitter is obtained through demodulation after signal processing. From a perspective of an entire physical process of sending, transmission, and receiving, the wireless sensing technology is very similar to a wireless communication process. Therefore, a wireless communication technology and the wireless sensing technology may be combined into one to sense a surrounding environment while communication is implemented.

In a possible implementation, a transmitting sensing node sends a sensing signal, the sensing signal reaches a to-be-sensed target, the to-be-sensed target reflects and/or scatters the sensing signal, and a receiving sensing node receives a sensing signal reflected and/or scattered by the to-be-sensed target. The receiving sensing node or another device processes the sensing signal received by the receiving sensing node, and may obtain a sensing result. Optionally, sensing may be performed by using a reference signal in wireless communication. To be specific, the sensing signal may be a reference signal, and the reference signal may also be referred to as a pilot signal. The reference signal for implementing sensing may be any signal, provided that a sequence known to both the transmitting sensing node and the receiving sensing node is sent. For example, the reference signal for implementing sensing may be a channel state information reference signal (channel state information reference signal, CSI-RS), a demodulation reference signal (demodulation reference signal, DMRS), or the like. This is not limited.

It may be understood that the transmitting sensing node and the receiving sensing node may be a same apparatus or different apparatuses. This is not limited. In embodiments of this application, at least one sensing mode is supported. For example, the sensing mode may be that one terminal is used as both a transmitting sensing node and a receiving sensing node. Alternatively, the sensing mode may be that one access network device is used as both a transmitting sensing node and a receiving sensing node. Alternatively, the sensing mode may be that one terminal is used as a transmitting sensing node, and another terminal is used as a receiving sensing node. Alternatively, the sensing mode may be that one access network device is used as a transmitting sensing node, and another access network device is used as a receiving sensing node. Alternatively, the sensing mode may be that an access network device is used as a transmitting sensing node, and a terminal is used as a receiving sensing node. Alternatively, the sensing mode may be that a terminal is used as a transmitting sensing node, and an access network device is used as a receiving sensing node, or the like. This is not limited. A sensing mode in which one terminal is used as both a transmitting sensing node and a receiving sensing node is used as an example. A specific sensing process may include: One terminal is used as a transmitting sensing node, and sends a sensing signal, the sensing signal reaches a to-be-sensed target, and the to-be-sensed target reflects and/or scatters the sensing signal. The terminal is also used as a receiving sensing node, and receives a reflected and/or scattered sensing signal. Optionally, the terminal or another device may analyze the sensing signal received by the terminal, to obtain a sensing result.

In a wireless sensing process, because the sensing node and/or the to-be-sensed target move/moves or the like, the sensing node may not be capable of continuing to support a current sensing task, and handover of the sensing node needs to be performed. For example, an access network device is used as a transmitting sensing node, and transmits a sensing signal, and a to-be-sensed target is a “human body”. When the sensing signal reaches the “human body”, the “human body” reflects and/or scatters the sensing signal. A terminal 1 is used as a receiving sensing node, and receives a sensing signal reflected and/or scattered by the “human body”. Optionally, the terminal 1, another device, or the like may analyze the sensing signal received by the terminal 1, to determine a sensing result. The sensing result may include health-related parameters such as a heart rate and breathing of the “human body”. Because the terminal 1 moves, power of the sensing signal that is received by the terminal 1 and that is reflected and/or scattered by the “human body” is less than a first threshold. Optionally, the terminal 1, the another device, or the like does not obtain the sensing result through analysis based on the sensing signal whose power is less than the first threshold, or accuracy of the sensing result obtained through analysis is less than a second threshold. In this case, to ensure stability, continuity, and the like of the current sensing task, it may be considered that handover of the receiving sensing node (the terminal 1) is performed. For example, the receiving sensing node is handed over from the terminal 1 to a terminal 2. In a current protocol, there is a lack of handover (handover) mechanisms for sensing tasks. How to hand over a sensing task to implement continuity, stability, and the like of a sensing service is a problem that needs to be resolved in embodiments of this application.

In embodiments of this application, a first communication apparatus may send a first handover request to a second communication apparatus, where the first handover request includes indication information of a context of a sensing task. Optionally, a target of the sensing task may be a passive target. The second communication apparatus may send a first handover response to the first communication apparatus, where the first handover response includes indication information indicating whether to agree to the first handover request. Optionally, the first handover response may be used as a response to the first handover request. If handover of the sensing task is agreed to, the first handover response includes indication information indicating that the first handover request is agreed to, in other words, includes indication information indicating that the handover is agreed to. Alternatively, if handover of the sensing task is not agreed to, the first handover response includes indication information indicating that the first handover request is rejected, in other words, includes indication information indicating that the handover is rejected. According to the solutions in embodiments of this application, handover of the sensing task can be implemented, and continuity, stability, and the like of the sensing service can be implemented.

### Embodiment 1

A first communication apparatus is a source sensing node, or a chip, a circuit, or the like used in the source sensing node. A second communication apparatus is a target sensing node, or a chip, a circuit, or the like used in the target sensing node. The source sensing node is a node before a sensing task is handed over, and the target sensing node is a node to which the sensing task is to be handed over, in other words, a node after the sensing task is handed over.

For example, the first communication apparatus is the source sensing node, and the second communication apparatus is the target sensing node. As shown in FIG. 2, a sensing task handover procedure is provided. The procedure includes the following steps.

Step 201: The source sensing node sends a first handover request to the target sensing node, where the first handover request includes indication information of a context of a sensing task.

In this embodiment of this application, a target of the sensing task may be referred to as a to-be-sensed target. Optionally, the to-be-sensed target may be a passive target, an active target, or the like. This is not limited. The passive target is usually a target or node that cannot access a network, for example, a human body, an intersection, or a conventional fuel vehicle. The active target is usually a target or node that can access a network, for example, a mobile phone, a computer, or a wearable device. Optionally, the passive target may also be referred to as a passive node, and the active target may also be referred to as an active node. It should be noted that in a possible implementation, although some active targets can access a network, the active targets are not sensed through the network. In this case, the active target may be sensed by using the method provided in this embodiment of this application. For example, a vehicle can access a wireless network, but the vehicle is not sensed through the wireless network. For example, positioning, speed measurement, or the like is performed on the vehicle. In this case, sensing such as positioning, speed measurement, or the like may be performed on the vehicle by using the method provided in this embodiment of this application.

In a possible implementation, the sensing task includes one or more of the following service types: environment sensing, health monitoring, home monitoring, mobile target sensing, or the like. Environment sensing is used to sense an environment of a specific area, and environment sensing is mainly used to obtain dynamic data of the environment of the specific area, for example, obtain dynamic data of a specific intersection. Health monitoring is mainly used to sense a vital sign. For example, sensing the vital sign includes but not limited to sensing a heartbeat, breathing, and the like. Home monitoring is mainly used to sense a behavior, a posture, or the like of a person, a pet, a robot, or the like in a home, or detect an exception, for example, water leakage, smoke, intrusion, and door opening or closing, in a home environment. Mobile target sensing is mainly used to sense a mobile target, for example, perform positioning, speed detection, or the like on the mobile target.

In a possible implementation, the context of the sensing task includes indication information of at least one of the following: an identifier of the sensing task, a sensing range of the sensing task, a performance requirement of the sensing task, a current sensing state, a service subtype of a service type of the sensing task, or the like.

The identifier (identifier, ID) of the sensing task may uniquely identify the sensing task.

The sensing range of the sensing task may be a geographical sensing range of a current sensing task. For example, the service type of the sensing task is home monitoring, and the sensing range of the sensing task may be a home monitoring range. The range may be a living room, a kitchen, a bedroom, or the like. Alternatively, the service type of the sensing task is environment sensing, and the sensing range of the sensing task may be a geographical area or the like of an environment that needs to be sensed in the sensing task. In a possible implementation, a plurality of ranges may be pre-divided, and the context of the sensing task may carry an identifier or the like of a range that needs to be sensed. Alternatively, an absolute coordinate system may be used to indicate a geographical range that needs to be sensed. The geographical range may be indicated by using longitude and latitude. Optionally, the geographical range may further include sensed height information and the like. Alternatively, a relative coordinate system may be used to indicate a geographical range or the like that needs to be sensed. The relative coordinate system needs to use an absolute coordinate system of a reference object as a reference, and the geographical range may be indicated by using a pitch angle and an azimuth. Optionally, the geographical range may further include a distance or the like of the sensed geographical range relative to an origin in the relative coordinate system.

The performance requirement of the sensing task may include a resolution of the sensing task, a frequency of sending a sensing signal, and/or the like. The resolution of the sensing task may be a distance resolution, an angle resolution, and/or the like of the sensing task. The angle resolution may include a pitch angle resolution, an azimuth resolution, and/or the like. The distance resolution may be a minimum distance that can distinguish between to-be-sensed targets or related parts of a to-be-sensed target in the sensing task, and the angle resolution may be a minimum angle that can distinguish between to-be-sensed targets or related parts of a to-be-sensed target in the sensing task. For example, the to-be-sensed target in the sensing task is a “human body”, and the distance resolution may be a minimum distance that can distinguish between two “human bodies”, or a minimum distance that can distinguish between related parts of a “human body”. The related parts may be two arms of the “human body”, two legs of the “human body”, or the like. The angle resolution may be a minimum angle that can distinguish between two “human bodies”, or a minimum angle that can distinguish between related parts of a “human body”.

Optionally, for health monitoring, the performance requirement of the sensing task may further include at least one of the following: a location of a health monitoring target object, a direction of the health monitoring target object, or the like. Optionally, the direction of the target object may be indicated by an angle of the target object. Optionally, for home monitoring, the performance requirement of the sensing task may further include at least one of the following: a home monitoring location, a home monitoring direction, or the like. Optionally, similarly, the home monitoring direction may be indicated by a home monitoring angle. For example, the angle in this application may be a pitch angle and an azimuth in a specific relative coordinate system.

The current sensing state may be a sensing result obtained by the source sensing node. For example, mobile target sensing is used an example. The current sensing state includes at least one of the following: a current location of the mobile target, a current moving speed of the mobile target, or a current moving direction of the mobile target. Optionally, the moving direction of the mobile target may be indicated by a moving angle of the mobile target.

The context of the sensing task includes the service subtype of the service type of the sensing task. The sensing task is associated with the service type. For example, each sensing task is associated with one service type. The service type may be further divided into a plurality of service subtypes. For example, health monitoring shown in Table 1 may be further divided into service subtypes such as heartbeat monitoring and breathing monitoring. For a sensing task whose service type is health monitoring, in a handover process of the sensing task, the context of the sensing task may further include indication information of the service subtype such as the heartbeat monitoring or the breathing monitoring. Alternatively, home monitoring shown in Table 1 may be further divided into service subtypes such as fall monitoring, exceptional posture monitoring, action recognition, or gesture recognition. For a sensing task whose service type is home monitoring, in a handover process, the context of the sensing task further includes indication information of a service subtype such as fall detection, exceptional posture detection, action recognition, or gesture recognition.

In a possible implementation, the context of the sensing task is associated with the service type of the sensing task. In other words, for different service types, there are contexts corresponding to the service types. For example, refer to Table 1.

TABLE 1

| Service | The context of the sensing task transferred in |
|---|---|
| type | the handover process includes indication |
| (Type) | information of at least one of the following: |
| Environment | {an identifier of the sensing task, |
| sensing | a sensing area of the sensing task, a |
| | resolution of the sensing task, or a |
| | frequency of sending a sensing signal} |
| Health | {an identifier of the sensing task, a |
| monitoring | health monitoring type (heartbeat |
| | monitoring/breathing monitoring, or the |
| | like), a current location of a health |
| | monitoring target object, a current |
| | direction of the health monitoring target |
| | object, a resolution of the sensing task, |
| | or a frequency of sending a sensing |
| | signal} |
| Home | {an identifier of the sensing task, |
| monitoring | a home monitoring type (fall |
| | detection/exceptional posture |
| | detection/action recognition/gesture |
| | recognition, or the like), a home |
| | monitoring range, a home monitoring |
| | location, a home monitoring direction, |
| | a resolution of the sensing task, or a |
| | frequency of sending a sensing signal} |
| Mobile target | {an identifier of the sensing task, a |
| sensing | type of a mobile target of the sensing task |
| | (a person, a large-sized vehicle, a |
| | small-sized vehicle, a medium-sized |
| | vehicle, an uncrewed aerial vehicle, |
| | or the like), a current location of the |
| | mobile target, a current moving speed |
| | of the mobile target, a current moving |
| | direction of the mobile target, a resolution |
| | of the sensing task, or a frequency |
| | of sending a sensing signal} |

For example, the service type of the sensing task is environment sensing. As shown in Table 1, the context of the sensing task includes the indication information of at least one of the following: the identifier of the sensing task, the sensing area of the sensing task, the resolution of the sensing task, the frequency of sending the sensing signal, or the like. For example, for the sensing task whose service type is environment sensing, the sensing task is specifically monitoring a road condition of a specific intersection. In this case, the sensing area indicated in the context of the sensing task is the foregoing intersection, the indicated resolution of the sensing task may be a minimum distance and/or angle that can distinguish between two vehicles at the intersection, the indicated frequency of the sensing signal may be a frequency at which the transmitting sensing node sends the sensing signal at the intersection, and the like.

For example, the service type of the sensing task is health monitoring. As shown in Table 1, the context of the sensing task includes the indication information of at least one of the following: the identifier of the sensing task, the health monitoring type (corresponding to the foregoing service subtype), the location or the direction of the health monitoring target object, the resolution of the sensing task, or the frequency of sending the sensing signal. For example, for the sensing task whose service type is health monitoring, the sensing task is specifically monitoring a heartbeat of a specific “family member”. In this case, the health monitoring type indicated in the context of the sensing task may be heartbeat monitoring, the indicated location, direction, or the like of the health monitoring target object may be a location, a direction, or the like of the “family member”, the indicated resolution of the sensing task may be a minimum distance resolution, a minimum angle resolution, or the like that can distinguish between parts of the “family member”, and the indicated frequency of sending the sensing signal may be a frequency at which the transmitting sensing node sends the sensing signal in the sensing task.

For example, the service type of the sensing task is mobile target sensing. As shown in Table 1, the context of the sensing task includes the indication information of at least one of the following: the identifier of the sensing task, the type of the mobile target of the sensing task (corresponding to the foregoing service subtype), the current location or the current moving direction of the mobile target, the resolution of the sensing task, the frequency of sending the sensing signal, or the like. The mobile target may be a person, a large-sized vehicle, a small-sized vehicle, a medium-sized vehicle, an uncrewed aerial vehicle, or the like. For example, for a sensing task for sensing a moving direction, a moving speed, or the like of the uncrewed aerial vehicle, the indicated type of the mobile target of the sensing task in the context of the sensing task is the uncrewed aerial vehicle, the indicated current location, current moving speed, or current moving direction of the mobile target may be a current location, a current moving speed, a moving direction, or the like of the uncrewed aerial vehicle in the sensing result of the source sensing node, the indicated resolution of the sensing task may be a minimum distance resolution or angle resolution, or the like that can distinguish between uncrewed aerial vehicles or parts in the uncrewed aerial vehicle, the indicated frequency of sending the sensing signal may be a frequency at which the transmitting sensing node sends the sensing signal in the sensing task of sensing the location, the speed, the direction, and/or the like of the uncrewed aerial vehicle.

In this embodiment of this application, the first handover request further includes indication information of the service type of the sensing task. The indication information of the service type may be carried in the context of the sensing task. That is, in addition to the foregoing information, the context of the sensing task may further include the indication information of the service type. Alternatively, the indication information of the service type may be carried outside the context of the sensing task. That is, the first handover request includes the context of the sensing task and the indication information of the service type.

In a possible implementation, the source sensing node may determine the target sensing node, and send the first handover request to the determined target sensing node. For example, when the source sensing node determines that the current sensing task cannot be supported, the source sensing node may determine at least one node that can support the current sensing task, and use the at least one node as the target sensing node to send the first handover request to the target sensing node.

In a possible implementation, the source sensing node is both a transmitting sensing node and a receiving sensing node. If the source sensing node is used as both the transmitting sensing node and the receiving sensing node, with movement of the source sensing node and/or the to-be-sensed target, power of the sensing signal received by the source sensing node is less than a first threshold. In this case, it is considered that the source sensing cannot continue to support the current sensing task. Optionally, the source sensing node or another device does not obtain a sensing result of the current sensing task through analysis based on the sensing signal whose power is less than the first threshold, or accuracy of the sensing result obtained through analysis is less than a second threshold or the like.

In another possible implementation, the source sensing node may be a transmitting sensing node or a receiving sensing node. In this case, when power received by the receiving sensing node is less than a first threshold, the receiving sensing node can only determine that a sensing link formed by the receiving sensing node and the transmitting sensing node is faulty. As a result, the receiving sensing node may not be clear about a specific need to hand over the transmitting sensing node or the receiving sensing node. For example, in this case, the receiving sensing node may indicate the transmitting sensing node to perform handover, or the receiving sensing node may perform handover by itself. Alternatively, the receiving sensing node indicates the transmitting sensing node to perform handover, and the receiving sensing node performs handover at the same time. This is not limited. In a possible implementation, for a dual-sensing mode formed by an access network device and a terminal, when a sensing link formed by the access network device and the terminal is faulty, and power of the received sensing signal is less than a first threshold, the terminal may be indicated to perform handover, or the like.

In another possible implementation, when determining that the source sensing node cannot continue to support the current sensing task, the source sensing node may broadcast the first handover request. A node that may receive the broadcast first handover request may be referred to as a candidate target sensing node. Each candidate target sensing node may obtain the context of the sensing task from the first handover request, and determine, based on the context of the sensing task, whether the current sensing task can be supported. For a process of determining, based on the context of the sensing task, whether the current sensing task can be supported, refer to descriptions in step 202. If the current sensing task is supported, the first handover response sent by the candidate target sensing node to the source sensing node includes indication information indicating that the handover is agreed to; or if the current sensing task is not supported, the first handover response sent by the candidate target sensing node to the source sensing node includes indication information indicating that the handover is rejected. Alternatively, only a candidate target sensing node that supports the current sensing task sends the first handover response to the source sensing node, and a candidate target sensing node that does not support the current sensing task no longer sends the first handover response to the source sensing node. Alternatively, on the contrary, only a candidate target sensing node that does not support the current sensing task sends the first handover response to the source sensing node, and a candidate target sensing node that supports the current sensing task no longer sends the first handover response to the source sensing node. This is not limited.

It may be understood that, in the foregoing possible implementation, there may be a case in which first handover responses sent by a plurality of candidate target sensing nodes all include the indication information indicating that the handover is agreed to, namely, a case in which the plurality of candidate target sensing nodes all agree to the handover. In a possible implementation, the source sensing node may determine that the plurality of candidate target sensing nodes agreeing to the handover all take over the current sensing task. Alternatively, the source sensing node may select at least one of the plurality of candidate target sensing nodes agreeing to the handover as the target sensing node. Optionally, the source sensing node may need to additionally notify another candidate target sensing node that the another candidate target sensing node does not need to take over the sensing task. For the another candidate target sensing node that does not need to take over the sensing task, the context or the like of the current sensing task may be deleted, and this is not limited; and/or the source sensing node may indicate the at least one selected target sensing node that takes over the current sensing task to take over the current sensing task.

Step 202: The target sensing node sends the first handover response to the source sensing node, where the first handover response includes indication information indicating whether the target sensing node agrees to the first handover request.

In a possible implementation, after receiving the first handover request, the target sensing node obtains the context of the sensing task, and determines, based on the context of the sensing task, whether the sensing task is supported. If the sensing task is supported, the first handover response includes the indication information indicating that the handover is agreed to; or if the sensing task is not supported, the first handover response includes the indication information indicating that the handover is rejected. In other words, the target sensing node may determine, based on the context of the sensing task, whether a condition of the sensing task is met, where the condition of the sensing task may be determined based on the context of the sensing task. If the target sensing node meets the condition of the sensing task, the first handover response includes the indication information indicating that the handover is agreed to; or if the target sensing node does not meet the condition of the sensing task, the first handover response includes the indication information indicating that the handover is rejected.

The determining, by the target sensing node, whether the sensing task is supported or whether the condition of the sensing task is met specifically includes the following possible implementations:

In a possible implementation, when the context of the sensing task includes indication information of the identifier of the sensing task, the target sensing node determines, based on the identifier of the sensing task, whether the current sensing task is supported. For example, the target sensing node may obtain a list of identifiers of the supported sensing task, and the target sensing node may determine whether an identifier of the current sensing task belongs to the list of identifiers of the supported sensing task. If the identifier of the current sensing task belongs to the list of identifiers of the supported sensing task, the target sensing node supports the current sensing task; otherwise, the target sensing node does not support the current sensing task. Alternatively, the target sensing node may determine a service type of the current sensing task based on the identifier of the sensing task. The target sensing node may obtain a list of supported service types. The target sensing node may determine whether the service type of the current sensing task belongs to the list of service types supported by the target sensing node. If the service type of the current sensing task belongs to the list of service types supported by the target sensing node, the target sensing node supports the current sensing task; otherwise, the target sensing node does not support the current sensing task.

In a possible implementation, when the context of the sensing task includes indication information of the sensing range of the sensing task, the target sensing node determines whether a sensing range of the target sensing node meets the sensing range of the sensing task. For example, when the sensing range of the target sensing node is less than the sensing range of the sensing task, or when an intersection set between the sensing range of the target sensing node and the sensing range of the sensing task is less than the sensing range of the sensing task, it is determined that the sensing task is not supported or the condition of the sensing task is not met.

In a possible implementation, when the context of the sensing task includes indication information of the performance requirement of the sensing task, the target sensing node determines whether sensing performance of the target sensing node meets the performance requirement of the sensing task. For example, the performance requirement of the sensing task includes the resolution, the frequency of sending the sensing signal, and/or the like. When a resolution supported by the target sensing node is less than the resolution in the performance requirement of the current sensing task, and/or a highest frequency, of sending the sensing signal, supported by the target sensing node is less than the frequency of sending the sensing signal in the performance requirement of the current sensing task, it may be considered that the target sensing node does not support the sensing task, does not meet the condition of the sensing task, or the like.

In a possible implementation, when the context of the sensing task includes indication information of the service subtype of the service type of the sensing task, the target sensing node may obtain a list of service subtypes supported by the target sensing node, and the target sensing node may determine whether a service subtype of the current sensing task belongs to the list of service subtypes. If the service subtype of the current sensing task belongs to the list of service subtypes, the target sensing node supports the sensing task or meets the condition of the sensing task; otherwise the target sensing node does not support the sensing task, does not meet the condition of the sensing task, or the like.

Optionally, in a possible implementation, the context of the sensing task further includes the indication information of the service type of the sensing task. Similarly, the target sensing node may obtain a list of service types supported by the target sensing node. If the service type of the current sensing task belongs to the list of service types supported by the target sensing node, the target sensing node supports the current sensing task; otherwise, the target sensing node does not support the current sensing task.

Optionally, in a possible implementation, the first handover request further includes indication information of a sensing mode. The sensing mode includes: A target communication apparatus is used as a transmitting sensing node; or the target communication apparatus is used as a receiving sensing node; or the target communication apparatus is used as both a transmitting sensing node and a receiving sensing node. The target communication apparatus may be a target sensing node, or a chip, a circuit, or the like used in the target sensing node. For example, the target communication apparatus is the target sensing node. The sensing mode includes: The target sensing node is used as the transmitting sensing node; or the target sensing node is used as the receiving sensing node; or the target sensing node is used as both the transmitting sensing node and the receiving sensing node. Optionally, for the first two sensing modes, the following may be further included: a specific device of a peer sensing node. For example, for the sensing mode in which the target sensing node is used as the transmitting sensing node, the sensing mode may further include: a device type of the receiving sensing node; or for the sensing mode in which the target sensing node is used as the receiving sensing node, the sensing mode may further include: a device type of the transmitting sensing node. The device type may include a network device, a terminal, or the like. In the foregoing possible implementation, the target sensing node may determine whether the sensing mode is supported. If the target sensing node supports the sensing mode and meets the sensing condition corresponding to the context of the sensing task, the first handover response includes the indication information indicating that the handover is agreed to; or if the target sensing node does not support the sensing mode and/or does not meet the sensing condition, the first handover response includes the indication information indicating that the handover is rejected.

In the foregoing possible implementation, for sending the sensing mode to the target sensing node, the following is mainly considered: The transmitting sensing node and the receiving sensing node have different requirements on the node. For example, the transmitting sensing node usually needs to transmit the sensing signal, and a requirement on the node is usually low. The receiving sensing node needs to receive a sensing signal reflected and/or scattered by the to-be-sensed target, and may further need to perform analysis, processing, or the like on the received sensing signal, and a requirement on the node is usually high. Therefore, when sending the first handover request to the target sensing node, the source sensing node also sends the sensing mode of the sensing task to the target sensing node, so that the target sensing node can determine whether the current sensing task can be supported.

In the foregoing possible implementation, the first handover request includes both the context of the sensing task and the indication information of the sensing mode. In another possible implementation, the context of the sensing task and the indication information of the sensing mode may be carried in two handover requests for sending. For example, the source sensing node sends a second handover request to the target sensing node, where the second handover request includes the indication information of the sensing mode. The target sensing node determines whether the sensing mode included in the second handover request is supported. If the sensing mode included in the second handover request is supported, the target sensing node sends, to the source sensing node, a second handover response that includes the indication information indicating that the handover is agreed to; or if the sensing mode included in the second handover request is not supported, the target sensing node sends, to the source sensing node, a second handover response that includes the indication information indicating that the handover is rejected. Alternatively, the target sensing node sends the second handover response to the source sensing node only when the target sensing node supports the sensing mode. When the target sensing node does not support the sensing mode, the target sensing node no longer sends the second handover response to the source sensing node or the like. When receiving the second handover response, the source sensing node considers by default that the target sensing node supports the sensing mode. For the target sensing node that does not receive the second handover response, it is considered by default that the target sensing node does not support the sensing mode. Alternatively, on the contrary, the target sensing node may send the second handover response to the source sensing node only when the target sensing node does not support the sensing mode. The target sensing node no longer sends the second handover response to the source sensing node when the target sensing node supports the sensing mode. When receiving the second handover response fed back by the target sensing node, the source sensing node considers by default that the target sensing node does not support the sensing mode. For the target sensing node that does not receive the fed-back second handover response, it is considered by default that the target sensing node supports the sensing mode or the like. This is not limited. In this embodiment of this application, an example in which the target sensing node feeds back a corresponding response to the source sensing node regardless of whether the target sensing node agrees to the handover is mainly used for description. Specifically, if the target sensing node agrees to the handover, the target sensing node sends the second handover response that includes the indication information indicating that the handover is agreed to; or if the target sensing node rejects the handover, the target sensing node sends the second handover response that includes the indication information indicating that the handover is rejected.

In this possible implementation, the source sensing node determines, based on the second handover response, the target sensing node that supports the sensing mode. There may be one or more determined target sensing nodes that support the sensing mode. This is not limited. The source sensing node sends, to the target sensing node, the first handover request that includes the indication information of the context of the sensing task. The target sensing node determines, based on the context of the sensing task, whether the condition of the sensing task is met. If the condition of the sensing task is met, the target sensing node sends, to the source sensing node, the first handover response that includes the indication information indicating that the handover is agreed to; or if the condition of the sensing task is not met, the target sensing node sends, to the source sensing node, the first handover response that includes the indication information indicating that the handover is rejected or the like. For a process of determining, based on the context of the sensing task, whether the condition of the sensing task is met, refer to the foregoing descriptions.

In a possible implementation, the source sensing node may determine at least one target sensing node, send a second handover request to the determined at least one target sensing node, further determine, based on a second handover response fed back by the at least one target sensing node, the at least one target sensing node that sends the first handover request, and finally determine, based on a first handover response fed back by the at least one target sensing node, the target sensing node that takes over the sensing task. In another possible implementation, the source sensing node may broadcast the second handover request. All nodes in a specific broadcast range may receive the second handover request. The nodes that receive the second handover request may determine whether a sensing mode in the second handover request is supported. If the sensing mode in the second handover request is supported, the sent second handover response includes the indication information indicating that the handover is agreed to; otherwise, the sent second handover response includes the indication information indicating that the handover is rejected. Then, a process in which the source sensing node determines, based on the second handover response, the at least one target sensing node that sends the first handover request is similar to the foregoing process, and is not described again.

The technical solution in Embodiment 1 is applicable to, but is not limited to, the following application scenarios in this embodiment of this application:

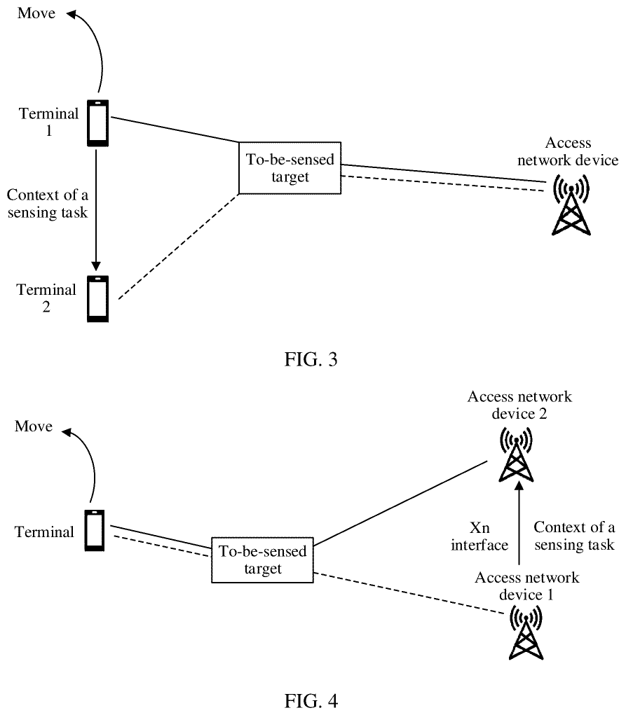

Application scenario 1: As shown in FIG. 3, an access network device and a terminal 1 jointly sense the to-be-sensed target. The sensing mode may be that the access network device is used as a transmitting sensing node, and the terminal 1 is used as a receiving sensing node. Alternatively, the terminal 1 is used as a transmitting sensing node, the access network device is used as a receiving sensing node, or the like. This is not limited. Because the terminal 1 moves, the terminal 1 cannot continue to support sensing of the sensing target. For example, if the terminal 1 is used as the transmitting sensing node, after a sensing signal transmitted by the terminal 1 is reflected and/or scattered by the to-be-sensed target, power of the sensing signal that arrives at the access network device is less than a first threshold. In this case, the access network device may indicate the terminal 1 to perform handover. Alternatively, if the terminal 1 is used as the receiving sensing node, power of the sensing signal received by the terminal 1 is less than the first threshold. In this case, the terminal 1 may determine, by itself, that handover needs to be performed.

In a possible implementation, as shown in FIG. 3, the terminal 1 may send a first handover request to a terminal 2, where the first handover request includes the indication information of the context of the current sensing task. The terminal 2 determines, based on the context of the sensing task, whether the current sensing task is supported. If the current sensing task is supported, a first handover response sent by the terminal 2 to the terminal 1 includes the indication information indicating that the handover is agreed to; or if the current sensing task is not supported, the first handover response sent by the terminal 2 to the terminal 1 includes the indication information indicating that the handover is rejected. In the scenario 1, the terminal 1 is used as the source sensing node, and the terminal 2 is used as the target sensing node.

In another possible implementation, when the terminal 1 cannot support the current sensing task, the access network device may initiate a sensing task handover procedure. For example, the access network device sends a first handover request to the terminal 2, where the first handover request includes the indication information of the context of the sensing task. The terminal 2 sends a first handover response to the access network device, where the first handover response includes the indication information indicating that the handover is agreed to or rejected. If the terminal 2 agrees to the handover, the access network device and the terminal 2 jointly sense the to-be-sensed target subsequently. It should be noted that, in the foregoing handover procedure initiated by the access network device, if the terminal 1 is used as the receiving sensing node, when determining that the terminal 1 needs to be handed over, the terminal 1 may send a handover request to the access network device; and when receiving the handover request, the access network device then initiates the handover procedure to the terminal 2.

Application scenario 2: As shown in FIG. 4, an access network device 1 and a terminal jointly sense the to-be-sensed target. Similar to the application scenario 1, a difference is that in the application scenario 2, when the terminal moves, the access network device that is jointly sensed with the terminal is handed over from the access network device 1 to an access network device 2. The access network device 1 may be referred to as a source sensing node, and the access network device 2 may be referred to as a target sensing node. The access network device 1 and the access network device 2 may be connected in a wired or wireless manner. In FIG. 4, an example in which two access network devices are connected through an Xn interface is used. The access network device 1 sends, to the access network device 2, a first handover request that includes the indication information of the context of the current sensing task. The access network device 2 determines, based on the context of the current sensing task, whether the access network device 2 can support the current sensing task. If the access network device 2 supports the current sensing task, the access network device 2 sends, to the access network device 1, a first handover response that includes the indication information indicating that the handover is agreed to; or if the access network device 2 does not support the current sensing task, the access network device 2 sends, to the access network device 1, a first handover response that includes the indication information indicating that the handover is rejected.

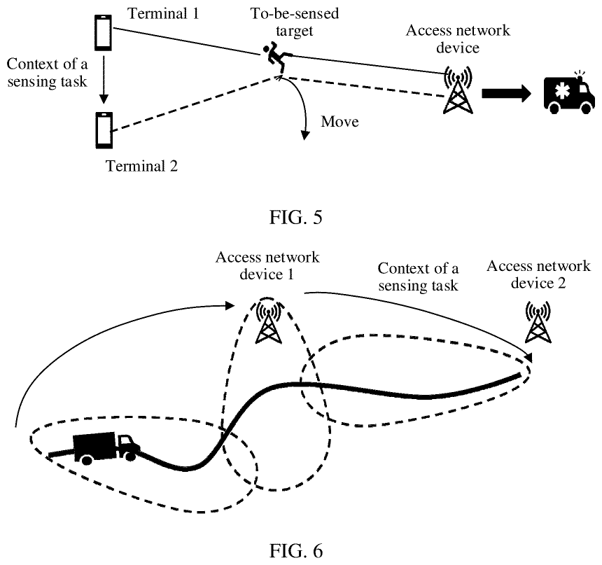

Application scenario 3: As shown in FIG. 5, the access network device and the terminal 1 jointly sense the to-be-sensed target, where the to-be-sensed target is a “human body”, and the sensing task is to sense a posture of the “human body”. Due to movement of the to-be-sensed target “human body”, the terminal that is jointly sensed with the access network device needs to be handed over from the terminal 1 to a terminal 2. The terminal 1 sends, to the terminal 2, a first handover request that includes the indication information of the context of the sensing task. The terminal 2 determines, based on the context of the current sensing task, whether the current sensing task is supported. If the current sensing task is supported, the terminal 2 sends, to the terminal 1, a first handover response that includes the indication information indicating that the handover is agreed to; otherwise, the terminal 2 sends, to the terminal 1, a first handover response that includes the indication information indicating that the handover is rejected. In the application scenario 3, the terminal 1 is the source sensing node, and the terminal 2 is the target sensing node.

In a scenario in FIG. 5, the access network device may initiate the sensing task handover procedure. For example, the access network device sends a first handover request to the terminal 2, where the first handover request includes the indication information of the context of the sensing task. The terminal 2 sends a first handover response to the access network device, where the first handover response includes the indication information indicating that the handover is agreed to or rejected. If the terminal 2 agrees to the handover, the access network device and the terminal 2 jointly sense the to-be-sensed target “human body” subsequently.

Application scenario 4: As shown in FIG. 6, the to-be-sensed target is a “vehicle”. In a traveling process, the “vehicle” passes through a plurality of access network devices. The sensing task is to determine a traveling parameter of the “vehicle”. The traveling parameter of the “vehicle” includes at least one of the following: location information of the “vehicle”, a traveling speed or a traveling direction of the “vehicle”, or the like. Optionally, the traveling direction of the vehicle may be indicated by using an angle. For example, a relative coordinate system is established, and a pitch angle and an azimuth in the relative coordinate system indicate the driving direction or the like of the vehicle.

When the “vehicle” is located in a sensing area of the access network device 1, the access network device 1 provides a sensing service for the “vehicle”. The process includes: The access network device 1 sends a sensing signal to the “vehicle”, the “vehicle” reflects and/or scatters the sensing signal when receiving the sensing signal, and the access network device 1 receives a reflected and/or scattered sensing signal. The access network device 1 or another device may determine a sensing result of the “vehicle” based on the reflected and/or scattered sensing signal received by the access network device 1. The sensing result includes at least one of the following: a current location of the “vehicle”, a current moving speed or direction of the “vehicle”, or the like. Because the “vehicle” travels, when the “vehicle” travels out of the sensing area of the access network device 1, a sensing node of the “vehicle” may be handed over from the access network device 1 to the access network device 2. For example, the access network device 1 sends a first handover request to an access network device 2, where the first handover request includes the indication information of the context of the sensing task. The access network device 2 sends a first handover response to the access network device 1 based on the context of the sensing task, where the first handover response includes the indication information indicating that the handover is agreed to or the indication information indicating that the handover is rejected. In the application scenario 4, the access network device 1 is used as the source sensing node, and the access network device 2 is used as the target sensing node. Optionally, the sensing area of the access network device may be described as follows: If the sensing signal sent by the access network device is reflected and/or scattered by the “vehicle”, power of the sensing signal received by the access network device is greater than or equal to a first threshold. Optionally, the access network device or the another device may obtain a sensing result through analysis based on the received sensing signal, or if accuracy of the sensing result obtained through analysis based on the received sensing signal is greater than or equal to a second threshold, it is considered that the “vehicle” is located in the sensing area of the current access network device; otherwise, it is considered that the “vehicle” travels out of the sensing area of the current access network device. In the diagram of FIG. 6, for the sensing area of the access network device, refer to the “ellipse” in FIG. 6.

It may be understood that, in the foregoing application scenario 1 and application scenario 3, the terminal 1 and the terminal 2 may directly communicate with each other. For example, the terminal 1 and the terminal 2 directly transmit the first handover request and the first handover response through a link such as a sidelink (sidelink, SL), Bluetooth, Wi-Fi, or near field communication (near field communication, NFC). Alternatively, the terminal 1 and the terminal 2 may indirectly communicate with each other. For example, communication between the terminal 1 and the terminal 2 may be forwarded through a Uu air interface. For example, the terminal 1 sends the first handover request to a corresponding access network device through the Uu air interface, and the corresponding access network device may send the first handover request to the terminal 2 through a downlink. Similarly, the terminal 2 may send the first handover response to a corresponding access network device through a Uu air interface, and the corresponding access network device may send the first handover response or the like to the terminal 1 through a downlink. This is not limited. The Uu air interface may be understood as universal UE to network interface (universal UE to network interface). Transmission over the Uu air interface may include uplink transmission and downlink transmission. The uplink transmission may mean that the terminal sends a signal to the access network device, and the downlink transmission may mean that the access network device sends a signal to the terminal. The signal transmitted in the uplink transmission may be referred to as uplink information or an uplink signal, and the signal transmitted in the downlink transmission may be referred to as downlink information or a downlink signal. In this embodiment of this application, the terminal 1 determines at least one candidate terminal from terminals near the terminal 1, and the candidate terminal includes the terminal 2. The terminal 1 sends a first handover request to the candidate terminal. The candidate terminal may send, to the terminal 1 based on the context of the sensing task, a first handover response that includes the indication information indicating that the handover is agreed to or rejected. Alternatively, the terminal 1 may broadcast the first handover request, and all terminals that can receive the broadcast first handover request may be referred to as candidate terminals. Each candidate terminal may send, to the terminal 1 based on the context of the current sensing task included in the first handover request, the first handover response that includes the indication information indicating that the handover is agreed to or rejected. It should be noted that, if a plurality of candidate terminals all agree to the handover, the plurality of candidate terminals may all take over the current sensing task; or one terminal may be selected from the plurality of candidate terminals, and the finally selected terminal takes over the current sensing task, or the like. This is not limited.

It may be understood that, in the foregoing application scenario 2 and application scenario 4, the access network device 1 and the access network device 2 may be connected in a wired or wireless manner. This is not limited. For example, the access network device 1 and the access network device 2 may communicate with each other through an Xn interface. Similar to the foregoing process, the access network device 1 may determine at least one candidate access network device, where the at least one candidate access network device includes the access network device 2; and sends the first handover request to the at least one candidate access network device. The access network device 1 determines, based on a first handover response fed back by the candidate access network device, an access network device to which the candidate access network device is finally handed over. Alternatively, the access network device 1 may send the first handover request to an access network device that is near the access network device 1 and that has an Xn interface with the access network device 1. The access network device that has the Xn interface with the access network device 1 may be referred to as a candidate access network device, and the candidate access network device includes the access network device 2. The access network device 1 determines, based on a first handover response fed back by the candidate access network device, an access network device to which the candidate access network device is finally handed over.

Optionally, in the foregoing application scenario 1 to application scenario 4, in addition to the indication information of the context of the current sensing task, the first handover request may further include the indication information of the sensing mode. Alternatively, before the source sensing node (which may be the terminal 1 or the access network device 1) sends the first handover request to the target sensing node (which may include the terminal 2 or the access network device 2), the source sensing node sends, to the target sensing node, the second handover request including the indication information of the sensing mode. For the target sensing node that sends the indication information indicating that the handover is agreed to, the source sensing node may further send, to the target sensing node, the first handover request including the context of the sensing task, or the like.

### Embodiment 2

A first communication apparatus is a source sensing node, or a chip, a circuit, or the like used in the source sensing node. A second communication apparatus is a sensing node other than a target sensing node, or a chip, a circuit, or the like used in the another sensing node. Optionally, a third communication apparatus is a target sensing node, or a chip, a circuit, or the like used in the target sensing node.

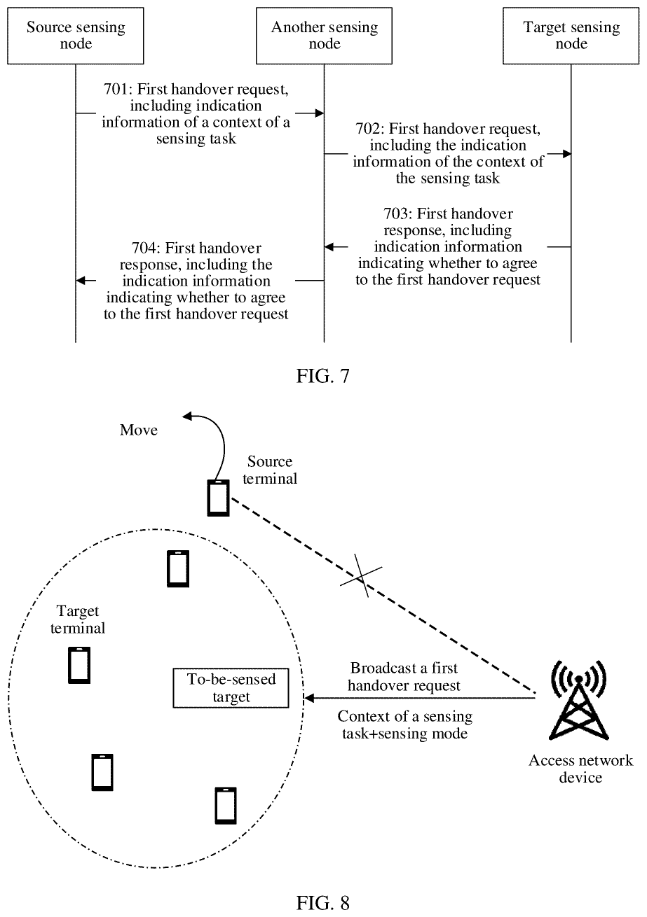

For example, the first communication apparatus is the source sensing node, the second communication apparatus is the another sensing node, and the third communication apparatus is the target sensing node. As shown in FIG. 7, a sensing task handover procedure is provided. The procedure includes the following steps.

Step 701: The source sensing node sends a first handover request to the another sensing node, where the first handover request includes indication information of a context of a sensing task. Optionally, a target of the sensing task is a passive target.

Step 702: The another sensing node sends the first handover request to the target sensing node.

Step 703: The target sensing node sends a first handover response to the another sensing node, where the first handover response includes indication information indicating whether to agree to the first handover request.

Optionally, for a process in which the target sensing node determines, based on the indication information of the context of the sensing task in the first handover request, whether the handover request is supported, refer to descriptions in Embodiment 1.

Step 704: The another sensing node sends the first handover response to the source sensing node.

Optionally, as described in Embodiment 1 above, the first handover request may further include indication information of a sensing mode of a current sensing task. Alternatively, the source sensing node may send a second handover request, where the second handover request includes the indication information of the sensing mode. In Embodiment 2, before sending the first handover request to the another sensing node, the source sensing node sends the second handover request to the another node, and the another sensing node forwards the second handover request to the target sensing node. The target sensing node sends, to the another sensing node based on the indication information of the sensing mode included in the second handover request, a second handover response that includes indication information indicating that the handover is agreed to or rejected. The another sensing node forwards the second handover response to the source sensing node. Optionally, the source sensing node may directly send the first handover request or the second handover request to the another sensing node. Alternatively, the source sensing node may broadcast the first handover request, the second handover request, or the like, and the another sensing node is a node that can receive the broadcast. Similarly, the another sensing node may directly send the first handover request or the second handover request to the target sensing node, or the another sensing node may broadcast the first handover request, the second handover request, or the like, and the target sensing node is a sensing node or the like that can receive the broadcast. This is not limited. Alternatively, in this embodiment of this application, the source sensing node may send the first handover request to the another sensing node; and when receiving the first handover request, the another sensing node sends the second handover request to the target sensing node. After the another sensing node determines, based on the second handover response fed back by the target sensing node, a target terminal that supports a current sensing mode, the another sensing node sends the first handover request to the target terminal that supports the current sensing mode. In this possible implementation, the source sensing node no longer sends the second handover request to the another sensing node, and the another sensing node generates the second handover request by itself and sends the second handover request to the target sensing node. This reduces overheads of sending the second handover request by the source sensing node.

For example, the source sensing node and the target sensing node are terminals, and the another sensing node is an access network device. As shown in FIG. 8, an application scenario of Embodiment 2 is provided: The terminal and the access network device perform joint sensing. As a source terminal moves, the source terminal no longer supports the current sensing task. The source terminal may send a first handover request to the access network device, where the first handover request includes the indication information of the context of the current sensing task. The access network device broadcasts the first handover request, and all terminals located in a specific geographical range of a to-be-sensed target may receive the broadcast first handover request. A plurality of terminals that receive the broadcast may be referred to as candidate target terminals. The candidate target terminal may determine, based on the indication information of the context of the current sensing task included in the first handover request, whether the candidate target terminal supports the current sensing task. For one candidate target terminal, if the candidate target terminal supports the current sensing task, the candidate target terminal may send, to the access network device, the indication information indicating that the handover is agreed to; otherwise, the candidate target terminal sends, to the access network device, the indication information indicating that the handover is rejected.

Optionally, as described above, in addition to the indication information of the context of the sensing task, the first handover request may further include: the indication information of the sensing mode of the sensing task. The sensing mode may be that the terminal is used as a transmitting sensing node, and the access network device is used as a receiving sensing node. Alternatively, the terminal is used as a receiving sensing node, and the access network device is used as a transmitting sensing node. Alternatively, the terminal is used as both a transmitting sensing node and a receiving sensing node, or the like. This is not limited. In a possible implementation, the first handover request sent by the terminal to the access network device includes the indication information of the context of the sensing task. After receiving the first handover request, the access network device adds the indication information of the sensing mode to the first handover request. The first handover request broadcast by the access network device to the target sensing node includes the indication information such as the context of the sensing task and the sensing mode. Alternatively, in another possible implementation, the first handover request sent by the terminal to the access network device includes the indication information such as the context of the sensing task and the sensing mode. When receiving the first handover request, the access network device directly broadcasts the first handover request including the indication information such as the context of the sensing task and the sensing mode, or the like. This is not limited.

As described above, the indication information such as the context of the sensing task and the sensing mode may be separately sent in two handover requests. To be specific, the first handover request includes the indication information of the context of the sensing task, and the second handover request includes the indication information of the sensing mode. In a possible implementation, the terminal sends the second handover request to the access network device, and the access network device broadcasts the second handover request to the candidate target terminal. The candidate target terminal sends, to the access network device, the second handover response that includes the indication information indicating that the handover is agreed to or rejected, and the access network device sends the second handover response to the source terminal. When determining that there is the second handover response indicating that the handover is agreed to, the source terminal then sends the first handover request to the access network device, and the access network device sends the first handover request to the terminal that supports the sensing mode. Alternatively, in another possible implementation, the terminal may not send the second handover request to the access network device, and the access network device triggers sending of the second handover request to the target terminal. For example, when receiving the first handover request sent by the terminal, the access network device may first broadcast the second handover request to the target terminal; and determine, based on the second handover response fed back by the target terminal, that there is the target terminal that supports the sensing mode. The access network device sends the first handover request or the like to the target terminal that supports the sensing mode.

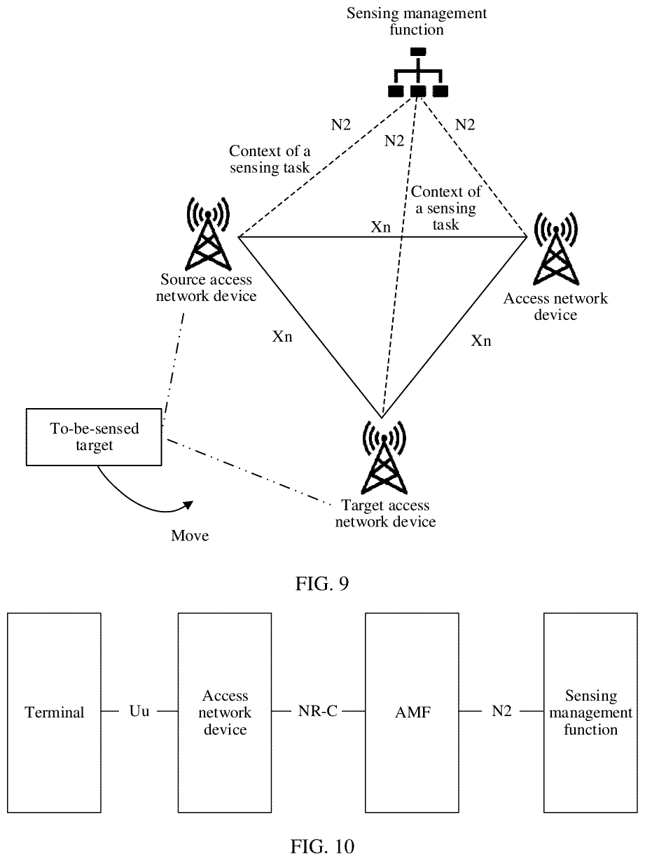

For example, the source sensing node and the target sensing node are both access network devices, the another sensing node is a sensing management function (sensing management function, SMF), the source sensing node is referred to as a source access network device, and the target sensing node is referred to as a target access network device. As shown in FIG. 9, an application scenario of Embodiment 2 is provided.

Due to movement of the to-be-sensed target, the source access network device cannot continue to support the current sensing task, and the sensing node needs to be handed over. The source access network device may send a first handover request to the sensing management function, where the first handover request includes the indication information of the context of the sensing task. The sensing management function may determine, based on the context of the sensing task, the target access network device that can take over the current sensing task, and send the first handover request to the target access network device. Because the sensing management function has predetermined that the target access network device can take over the current sensing task, the target access network device does not need to perform further determining, and may take over the current sensing task based on the context of the sensing task. Optionally, the target access network device may send a first handover response to the sensing management function, where the first handover response includes the indication information indicating that the handover is agreed to. The sensing management function may send the first handover response to the source access network device, to notify the source access network device that the current sensing task has been successfully handed over. Optionally, the first handover response may further include the indication information of the target sensing node, or the like. In another possible implementation, when receiving the first handover request of the source access network device, the sensing management function may send the first handover request to at least one target access network device. Any one of the at least one target access network device needs to determine, based on the context of the sensing task, whether the target access network device supports the current sensing task. If the target access network device supports the current sensing task, the target access network device sends, to the sensing management function, a first handover response that includes the indication information indicating that the handover is agreed to; otherwise, the target access network device sends, to the sensing management function, a first handover response that includes the indication information indicating that the handover is rejected, or the like. Further, when a plurality of candidate target access network devices all agree to the handover, the sensing management function may need to further determine one target access network device from the plurality of candidate target access network devices agreeing to the handover. The determined target access network device is used as an access network device that takes over the sensing task of the source access network device. In this case, the sensing management function may send, to the source access network device, the first handover response that includes the indication information indicating that the handover is agreed to. Optionally, the first handover response may further include an identifier or the like of the determined target access network device that takes over the sensing task of the source access network device. It may be understood that, in this embodiment of this application, if there may be a target node that cannot be determined by the sensing management function to take over the current sensing task, for example, all access network devices do not support the current sensing task, the sensing management function may send, to the source access network device, the first handover response that includes the indication information indicating that the handover is rejected. In this case, handover of the current sensing task fails. Alternatively, if the first handover response that is sent by any target access network device and that is received by the sensing management function includes the indication information indicating that the handover is rejected, the first handover response sent by the sensing management function to the source access network device also includes the indication information indicating that the handover is rejected.

Optionally, the first handover request may further include the indication information of the sensing mode. Alternatively, the source access network device may send a second handover request to the sensing management function, where the second handover request includes the indication information of the sensing mode. The sensing management function sends the second handover request to the candidate target access network device. For any candidate target access network device, if the sensing mode indicated in the second handover request is supported, the second handover response sent by the candidate target access network device to the sensing management function includes the indication information indicating that the handover is agreed to; or if the sensing mode indicated in the second handover request is not supported, the second handover response sent by the target access network device to the sensing management function includes the indication information indicating that the handover is rejected. When receiving the second handover response, the sensing management function may send the second handover response to the source access network device. If the source access network device finds that there is a candidate target terminal that supports the current sensing mode, that is, in the second handover response, there is the indication information indicating that the handover is agreed to, the source access network device may send a first handover request to the sensing management function, where the first handover request includes the indication information of the context of the sensing task. The sensing management function sends the first handover request to the candidate target terminal that agrees to the handover (namely, the target terminal that supports the current sensing mode). Further, the candidate target terminal that supports the current sensing mode determines, based on the context of the sensing task, whether to finally agree to the handover. If the handover is finally agreed to, the second handover response sent by the candidate target terminal to the sensing management function includes the indication information indicating that the handover is agreed to; otherwise, the second handover response sent by the candidate target terminal to the sensing management function includes the indication information indicating that the handover is rejected. Alternatively, in another possible implementation, when receiving a first handover request from the source access network device, the sensing management function first sends, to a plurality of candidate target terminals, a second handover request that includes the indication information of the sensing mode; and when receiving a second handover response fed back by the candidate target terminal, the sensing management function then sends the first handover request or the like to the candidate target terminal that supports the current sensing mode.

In a possible implementation, the sensing management function may be located on a core network side. For example, as shown in FIG. 10, the terminal is connected to the access network device through a Uu air interface, and the access network device is connected to the sensing management function through an access and mobility management function (access and mobility management function, AMF), or the access network device may be directly connected to the sensing management function or the like. This is not limited. The AMF transparently transmits or forwards transmission between the access network device and the sensing management function. The access network device may communicate with the AMF through an NG-C interface, and the NG-C uses an NG application protocol (NG application protocol, NGAP). An interface between the AMF and the sensing management function may be an N2 interface. In another possible implementation, the sensing management function may be located on an access network device side. If the sensing management function is located on the access network device side, communication between the sensing management function and the access network device belongs to internal communication of the access network device.

In this embodiment of this application, a name of the sensing management function is not limited, and the sensing management function is mainly used to manage sensing tasks in a unified manner. For example, the sensing management function may set a unique number or index for each sensing task, and the number or index may uniquely identify the sensing task. The sensing management function may also manage sensing tasks by using a service type for classification. For example, the sensing management function may classify all sensing tasks into service types such as environment sensing, health monitoring, home monitoring, and mobile target sensing, and manage a sensing task specifically included in each service type, or the like. Optionally, when receiving a sensing signal reflected and/or scattered by the to-be-sensed target, the receiving sensing node may directly report the received sensing signal to the sensing management function, or report the received sensing signal to the sensing management function after preliminarily processing the received sensing signal, or the like. The sensing management function may process the signal reported by the receiving sensing node, to obtain a sensing result. Further, the sensing management function may send the sensing result to a requester of the sensing task. For example, the requester of the sensing task may be a server corresponding to the environment sensing, the health monitoring, the home monitoring, the mobile target sensing, or the like. The sensing management function may also be referred to as a name such as a management function. This is not limited. As described above, the sensing management function may be located on the core network side to manage the sensing task, or the sensing management function may be located on the access network device side to manage the sensing task, or the like. This is not limited.

It should be noted that:

1. In addition to different focus descriptions of Embodiments, for repeated content in embodiments, refer to each other.

2. “Indication” is described as follows: The indication may explicitly or directly indicate corresponding information, or implicitly or indirectly indicate corresponding information, or the like. This is not limited. For example, in the descriptions of this application, the context of the sensing task includes indication information of at least one of the following: an identifier of the sensing task, a sensing range of the sensing task, a performance requirement of the sensing task, a current sensing state, or a service subtype of a service type of the sensing task. The identifier of the sensing task is used as an example. The context of the sensing task may directly carry the identifier of the sensing task, or the context of the sensing task may carry other information corresponding to the identifier of the sensing task, and the information may implicitly or indirectly indicate the identifier of the sensing task.

3. In embodiments of this application, an example in which the solutions provided in this application are applied to a wireless communication system is used for description. It may be understood that the solutions in embodiments of this application may be further applied to another communication system. For example, in a Wi-Fi communication system, the sensing node may be an AP, a station (station, STA), a wireless router, or the like. The station may be the terminal described above. In particular, it should be noted that, when the station is a smart home device in the foregoing terminal, the smart home device may be specifically a home electric device such as a television, a smart sound box, a smart refrigerator, or an electronic lock.

It may be understood that, to implement the functions in the foregoing embodiments, a first communication apparatus, a second communication apparatus, a third communication apparatus, and the like include corresponding hardware structures and/or software modules for performing the functions. A person skilled in the art should be easily aware that, in combination with the units and method steps in the examples described in embodiments disclosed in this application, this application can be implemented in a form of hardware or a combination of hardware and computer software in this application. Whether a function is performed by hardware or hardware driven by computer software depends on particular application scenarios and possible implementation constraints of the technical solutions.

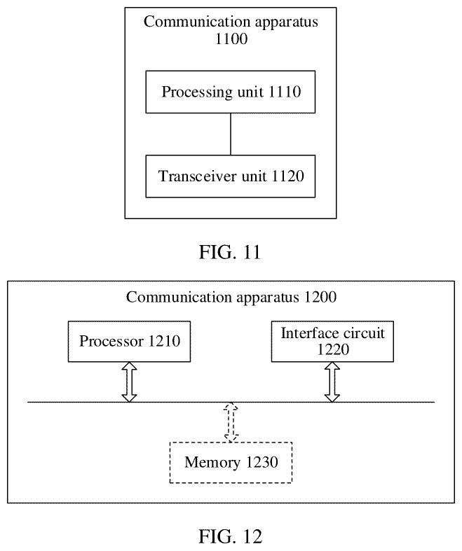

FIG. 11 and FIG. 12 are diagrams of possible structures of communication apparatuses according to embodiments of this application. The communication apparatuses may be configured to implement functions of the first communication apparatus or the second communication apparatus in the foregoing method embodiments, and therefore can also implement beneficial effect of the foregoing method embodiments. In embodiments of this application, the communication apparatus may be one of the terminals 120a to 120j shown in FIG. 1, or may be the access network device 110a or 110b shown in FIG. 1, or may be a module (for example, a chip) used in the terminal or the access network device.

As shown in FIG. 11, the communication apparatus 1100 includes a processing unit 1110 and a transceiver unit 1120. The communication apparatus 1100 is configured to implement functions of the first communication apparatus or the second communication apparatus in the foregoing method embodiments.

When the communication apparatus 1100 is configured to implement a function of the first communication apparatus in the foregoing method embodiments, the transceiver unit 1120 is configured to: send a first handover request to a second communication apparatus, where the first handover request includes indication information of a context of a sensing task, and optionally, a target of the sensing task is a passive target; and receive a first handover response from the second communication apparatus, where the first handover response includes indication information indicating whether to agree to the first handover request. Optionally, the processing unit 1110 is configured to generate the first handover request, process the first handover response, and the like.

In a possible implementation, the context of the sensing task includes indication information of at least one of the following: an identifier of the sensing task, a sensing range of the sensing task, a performance requirement of the sensing task, a current sensing state, or a service subtype of a service type of the sensing task.

In a possible implementation, the context of the sensing task is associated with the service type of the sensing task. For example, the service type of the sensing task is environment sensing, and the context of the sensing task includes indication information of at least one of the following: the identifier of the sensing task, a sensing area of the sensing task, a resolution of the sensing task, or a frequency of sending a sensing signal. Alternatively, the service type of the sensing task is health monitoring, and the context of the sensing task includes indication information of at least one of the following: the identifier of the sensing task, a health monitoring type, a current location of a health monitoring target object, a current direction of the health monitoring target object, a resolution of the sensing task, or a frequency of sending a sensing signal. Alternatively, the service type of the sensing task is home monitoring, and the context of the sensing task includes indication information of at least one of the following: the identifier of the sensing task, a home monitoring type, a home monitoring range, a home monitoring location, a home monitoring direction, a resolution of the sensing task, or a frequency of sending a sensing signal. Alternatively, the service type of the sensing task is mobile target sensing, and the context of the sensing task includes indication information of at least one of the following: the identifier of the sensing task, a type of a mobile target of the sensing task, a current location of the mobile target, a current moving speed of the mobile target, a current moving direction of the mobile target, a resolution of the sensing task, or a frequency of sending a sensing signal.

In a possible implementation, the first handover request further includes indication information of the service type of the sensing task.

In a possible implementation, the first handover request further includes indication information of a sensing mode.

In a possible implementation, the transceiver unit 1120 is further configured to: send a second handover request to the second communication apparatus, where the second handover request includes indication information of a sensing mode; and receive a second handover response from the second communication apparatus, where the second handover response includes indication information indicating that the second handover request is agreed to.

Optionally, the sensing mode includes: A target communication apparatus is used as a transmitting sensing node; or the target communication apparatus is used as a receiving sensing node; or the target communication apparatus is used as both a transmitting sensing node and a receiving sensing node.

In a possible implementation, when sending the first handover request or the second handover request to the second communication apparatus, the transceiver unit 1120 is specifically configured to broadcast the first handover request or the second handover request, where the second communication apparatus is an apparatus that can receive the broadcast.

When the communication apparatus 1100 is configured to implement the function of the second communication apparatus in the foregoing method embodiments, the transceiver unit 1120 is configured to:
receive a first handover request from a first communication apparatus, where the first handover request includes indication information of a context of a sensing task; and optionally, a target of the sensing task is a passive target; and send a first handover response to the first communication apparatus, where the first handover response includes indication information indicating whether to agree to the first handover request. Optionally, the processing unit 1110 is configured to process the first handover request, generate the first handover response, and the like.

In a possible implementation, the context of the sensing task includes indication information of at least one of the following: an identifier of the sensing task, a sensing range of the sensing task, a performance requirement of the sensing task, a current sensing state, or a service subtype of a service type of the sensing task.

In a possible implementation, the context of the sensing task is associated with the service type of the sensing task. For example, the service type of the sensing task is environment sensing, and the context of the sensing task includes indication information of at least one of the following: the identifier of the sensing task, a sensing area of the sensing task, a resolution of the sensing task, or a frequency of sending a sensing signal. Alternatively, for example, the service type of the sensing task is health monitoring, and the context of the sensing task includes indication information of at least one of the following: the identifier of the sensing task, a health monitoring type, a current location of a health monitoring target object, a current direction of the health monitoring target object, a resolution of the sensing task, or a frequency of sending a sensing signal. Alternatively, for example, the service type of the sensing task is home monitoring, and the context of the sensing task includes indication information of at least one of the following: the identifier of the sensing task, a home monitoring type, a home monitoring range, a home monitoring location, a home monitoring direction, a home monitoring resolution, or a frequency of sending a sensing signal. Alternatively, for example, the service type of the sensing task is mobile target sensing, and the context of the sensing task includes indication information of at least one of the following: the identifier of the sensing task, a type of a mobile target of the sensing task, a current location of the mobile target, a current moving speed of the mobile target, a current moving direction of the mobile target, a resolution of the sensing task, or a frequency of sending a sensing signal.

In a possible implementation, the first handover request further includes indication information of the service type of the sensing task.

In a possible implementation, the processing unit 1110 is further configured to determine, based on the context of the sensing task, whether a condition of the sensing task is met. If the condition of the sensing task is met, the first handover response includes indication information indicating agreement; or if the condition of the sensing task is not met, the first handover response includes indication information indicating rejection.

In a possible implementation, the transceiver unit 1120 is further configured to send the first handover request to a third communication apparatus; and
and receive the first handover response from the third communication apparatus.

In a possible implementation, the first handover request further includes indication information of a sensing mode.

In a possible implementation, the processing unit 1110 is further configured to determine whether the sensing mode can be supported. If the second communication apparatus supports the sensing mode and meets a sensing condition corresponding to the context of the sensing task, the first handover response includes the indication information indicating agreement; or if the second communication apparatus does not meet the sensing condition and/or does not support the sensing mode, the first handover response includes the indication information indicating rejection.

In a possible implementation, the transceiver unit 1120 is further configured to: receive a second handover request from the first communication apparatus, where the second handover request includes indication information of a sensing mode; and send a second handover response to the first communication apparatus, where the second handover response includes indication information indicating that the second handover request is agreed to.

In a possible implementation, the transceiver unit 1120 is further configured to: send the second handover request to the third communication apparatus; and receive the second handover response from the third communication apparatus.

In a possible implementation, the sensing mode includes: A target communication apparatus is used as a transmitting sensing node; or the target communication apparatus is used as a receiving sensing node; or the target communication apparatus is used as both a transmitting sensing node and a receiving sensing node.

In a possible implementation, the first handover request or the second handover request is broadcast, and the second communication apparatus or the third communication apparatus is an apparatus that can receive the broadcast.

As shown in FIG. 12, the communication apparatus 1200 includes a processor 1210 and an interface circuit 1220. The processor 1210 and the interface circuit 1220 are coupled to each other. It may be understood that the interface circuit 1220 may be a transceiver or an input/output interface. Optionally, the communication apparatus 1200 may further include a memory 1230, configured to: store instructions executed by the processor 1210, or store input data required by the processor 1210 to run the instructions, or store data generated after the processor 1210 runs the instructions.

When the communication apparatus 1200 is configured to implement the method in the foregoing method embodiments, the processor 1210 is configured to implement functions of the processing unit 1110, and the interface circuit 1220 is configured to implement functions of the transceiver unit 1120.

When the communication apparatus is a chip used in a terminal, the chip in the terminal implements the functions of the terminal in the foregoing method embodiments. The chip in the terminal receives information from another module (for example, a radio frequency module or an antenna) in the terminal, where the information is sent by an access network device to the terminal. Alternatively, the chip in the terminal sends information to another module (for example, a radio frequency module or an antenna) in the terminal, where the information is sent by the terminal to an access network device.

When the communication apparatus is a module used in an access network device, the module in the access network device implements the functions of the access network device in the foregoing method embodiments. The module in the access network device receives information from another module (for example, a radio frequency module or an antenna) in the access network device, where the information is sent by a terminal to the access network device. Alternatively, the module in the access network device sends information to another module (for example, a radio frequency module or an antenna) in the access network device, where the information is sent by the access network device to a terminal. The module in the access network device herein may be a baseband chip of the access network device, or may be a DU or another module. The DU herein may be a DU in an open radio access network (open radio access network, O-RAN) architecture.

It may be understood that the processor in embodiments of this application may be a baseband processor, a central processing unit (central processing unit, CPU), or a logic circuit, or may be another general-purpose processor, a digital signal processor (digital signal processor, DSP), an application-specific integrated circuit (application-specific integrated circuit, ASIC), a field programmable gate array (field programmable gate array, FPGA) or another programmable logic device, a transistor logic device, a hardware component, or any combination thereof. The general-purpose processor may be a microprocessor or any conventional processor.

The method steps in embodiments of this application may be implemented in a hardware manner, or may be implemented in a manner of executing software instructions by the processor. The software instructions may include a corresponding software module. The software module may be stored in a random access memory, a flash memory, a read-only memory, a programmable read-only memory, an erasable programmable read-only memory, an electrically erasable programmable read-only memory, a register, a hard disk, a removable hard disk, a CD-ROM, or any other form of storage medium well-known in the art. For example, a storage medium is coupled to a processor, so that the processor can read information from the storage medium and write information into the storage medium. Certainly, the storage medium may alternatively be a component of the processor. The processor and the storage medium may be disposed in an ASIC. In addition, the ASIC may be located in an access network device or a terminal. Certainly, the processor and the storage medium may exist in the access network device or the terminal as discrete components.

All or some of the foregoing embodiments may be implemented by software, hardware, firmware, or any combination thereof. When software is used to implement embodiments, all or some of embodiments may be implemented in a form of a computer program product. The computer program product includes one or more computer programs or instructions. When the computer program or the instructions are loaded and executed on a computer, all or some of procedures or functions in embodiments of this application are performed. The computer may be a general-purpose computer, a dedicated computer, a computer network, a network device, user equipment, or another programmable apparatus. The computer program or the instructions may be stored in a computer-readable storage medium, or may be transmitted from a computer-readable storage medium to another computer-readable storage medium. For example, the computer program or the instructions may be transmitted from a website, computer, server, or data center to another website, computer, server, or data center in a wired or wireless manner. The computer-readable storage medium may be any usable medium accessible by the computer, or a data storage device, for example, a server or a data center, integrating one or more usable media. The usable medium may be a magnetic medium, for example, a floppy disk, a hard disk, or a magnetic tape; or may be an optical medium, for example, a digital video disc; or may be a semiconductor medium, for example, a solid-state drive. The computer-readable storage medium may be a volatile or non-volatile storage medium, or may include two types of storage media: a volatile storage medium and a non-volatile storage medium.

In embodiments of this application, unless otherwise stated or there is a logic conflict, terms and/or descriptions in different embodiments are consistent and may be mutually referenced, and technical features in different embodiments may be combined based on an internal logical relationship thereof, to form a new embodiment.

In this application, “at least one” means one or more, and “a plurality of” means two or more. “And/or” describes an association relationship between associated objects and represents that three relationships may exist. For example, A and/or B may represent the following cases: Only A exists, both A and B exist, and only B exists, where A and B may be singular or plural. In the text descriptions of this application, the character “/” represents an “or” relationship between the associated objects. In a formula in this application, the character “/” represents a “division” relationship between the associated objects. “Including at least one of A, B, and C” may represent: including A; including B; including C; including A and B; including A and C; including B and C; and including A, B, and C.

It may be understood that various numbers in embodiments of this application are merely used for differentiation for ease of description, and are not used to limit the scope of embodiments of this application. Sequence numbers of the foregoing processes do not mean an execution sequence, and the execution sequence of the processes should be determined based on functions and internal logic of the processes.

1. A sensing task handover method, comprising:
sending, by a first communication apparatus, a first handover request to a second communication apparatus, wherein the first handover request comprises indication information of a context of a sensing task; and
receiving, by the first communication apparatus, a first handover response from the second communication apparatus, wherein the first handover response comprises indication information indicating whether to agree to the first handover request.

2. The method according to claim 1, wherein a target of the sensing task is a passive target.

3. The method according to claim 1, wherein the context of the sensing task comprises indication information of at least one of the following:
an identifier of the sensing task, a sensing range of the sensing task, a performance requirement of the sensing task, a current sensing state, or a service subtype of a service type of the sensing task.

4. The method according to claim 3, wherein the context of the sensing task is associated with the service type of the sensing task.

5. The method according to claim 4, wherein the service type of the sensing task is environment sensing, and the context of the sensing task comprises indication information of at least one of the following:
the identifier of the sensing task, a sensing area of the sensing task, a resolution of the sensing task, or a frequency of sending a sensing signal.

6. The method according to claim 4, wherein the service type of the sensing task is health monitoring, and the context of the sensing task comprises indication information of at least one of the following:
the identifier of the sensing task, a health monitoring type, a current location of a health monitoring target object, a current direction of the health monitoring target object, a resolution of the sensing task, or a frequency of sending a sensing signal.

7. The method according to claim 4, wherein the service type of the sensing task is home monitoring, and the context of the sensing task comprises indication information of at least one of the following: the identifier of the sensing task, a home monitoring type, a home monitoring range, a home monitoring location, a home monitoring direction, a resolution of the sensing task, or a frequency of sending a sensing signal; or
wherein the service type of the sensing task is mobile target sensing, and the context of the sensing task comprises indication information of at least one of the following: the identifier of the sensing task, a type of a mobile target of the sensing task, a current location of the mobile target, a current moving speed of the mobile target, a current moving direction of the mobile target, a resolution of the sensing task, or a frequency of sending a sensing signal.

8. A sensing task handover method, comprising:
receiving, by a second communication apparatus, a first handover request from a first communication apparatus, wherein the first handover request comprises indication information of a context of a sensing task; and
sending, by the second communication apparatus, a first handover response to the first communication apparatus, wherein the first handover response comprises indication information indicating whether to agree to the first handover request.

9. The method according to claim 8, wherein a target of the sensing task is a passive target.

10. The method according to claim 8, wherein the context of the sensing task comprises indication information of at least one of the following:
an identifier of the sensing task, a sensing range of the sensing task, a performance requirement of the sensing task, a current sensing state, or a service subtype of a service type of the sensing task.

11. The method according to claim 8, wherein the context of the sensing task is associated with the service type of the sensing task.

12. The method according to claim 8, wherein the service type of the sensing task is environment sensing, and the context of the sensing task comprises indication information of at least one of the following:
the identifier of the sensing task, a sensing area of the sensing task, a resolution of the sensing task, or a frequency of sending a sensing signal.

13. The method according to claim 8, wherein the service type of the sensing task is health monitoring, and the context of the sensing task comprises indication information of at least one of the following:
the identifier of the sensing task, a health monitoring type, a current location of a health monitoring target object, a current direction of the health monitoring target object, a resolution of the sensing task, or a frequency of sending a sensing signal; or
wherein the service type of the sensing task is home monitoring, and the context of the sensing task comprises indication information of at least one of the following: the identifier of the sensing task, a home monitoring type, a home monitoring range, a home monitoring location, a home monitoring direction, a home monitoring resolution, or a frequency of sending a sensing signal.

14. A communication apparatus, comprising:
at least one processor; and
a non-transitory computer-readable medium including computer-executable instructions that, when executed by the processor, cause the apparatus to:
send a first handover request to a second communication apparatus, wherein the first handover request comprises indication information of a context of a sensing task; and
receive a first handover response from the second communication apparatus, wherein the first handover response comprises indication information indicating whether to agree to the first handover request.

15. The communication apparatus according to claim 14, wherein a target of the sensing task is a passive target.

16. The communication apparatus according to claim 14, wherein the context of the sensing task comprises indication information of at least one of the following:
an identifier of the sensing task, a sensing range of the sensing task, a performance requirement of the sensing task, a current sensing state, or a service subtype of a service type of the sensing task.

17. The communication apparatus according to claim 16, wherein the context of the sensing task is associated with the service type of the sensing task.

18. The communication apparatus according to claim 17, wherein the service type of the sensing task is environment sensing, and the context of the sensing task comprises indication information of at least one of the following:
the identifier of the sensing task, a sensing area of the sensing task, a resolution of the sensing task, or a frequency of sending a sensing signal.

19. The communication apparatus according to claim 17, wherein the service type of the sensing task is health monitoring, and the context of the sensing task comprises indication information of at least one of the following:
the identifier of the sensing task, a health monitoring type, a current location of a health monitoring target object, a current direction of the health monitoring target object, a resolution of the sensing task, or a frequency of sending a sensing signal.

20. The communication apparatus according to claim 17, wherein the service type of the sensing task is home monitoring, and the context of the sensing task comprises indication information of at least one of the following: the identifier of the sensing task, a home monitoring type, a home monitoring range, a home monitoring location, a home monitoring direction, a resolution of the sensing task, or a frequency of sending a sensing signal; or
wherein the service type of the sensing task is mobile target sensing, and the context of the sensing task comprises indication information of at least one of the following: the identifier of the sensing task, a type of a mobile target of the sensing task, a current location of the mobile target, a current moving speed of the mobile target, a current moving direction of the mobile target, a resolution of the sensing task, or a frequency of sending a sensing signal.
